(19) United States
(12) Patent Application Publication
(10) Pub. No.: US 2020/0023399 A1
(43) Pub. Date: Jan. 23, 2020

(54) PAINTING ASSEMBLY

(71) Applicant: TTI (MACAO COMMERCIAL OFFSHORE) LIMITED, Macau (MO)

(72) Inventors: Patrick J. Gordon, Greenville, SC (US); Jacob F. Creasman, Anderson, SC (US); Clinton C. Thackery, Clemson, SC (US)

(21) Appl. No.: 16/514,838

(22) Filed: Jul. 17, 2019

Related U.S. Application Data
(60) Provisional application No. 62/699,399, filed on Jul. 17, 2018.

(51) Int. Cl. B05B 13/00; B05B 13/02

(52) U.S. Cl. CPC B05B 13/005; B05B 13/02

(57) ABSTRACT

A painting assembly may be configured to removably support a paint container having an outer surface. The assembly may include a paint sprayer having a mounting portion with a support portion and a flange, a motor, a pump, a siphon line configured to draw paint from the paint container, and a dispensing line configured to dispense paint via pressure from the pump. The assembly may include a dolly having a base and wheels. The base may have a sidewall with an upper edge. When the paint container is received in the base, the support portion of the mounting portion may be configured to rest on the paint container and the flange may be configured to extend over the outer surface of the paint container, such that the paint sprayer may be supported on the paint container and inhibited from moving in a lateral direction off of the paint container.

### CROSS-REFERENCE TO RELATED APPLICATIONS

This application claims priority to co-pending U.S. Provisional Patent Application No. 62/699,399 filed on Jul. 17, 2018, the entire content of which is incorporated herein by reference.

### FIELD OF THE DISCLOSURE

The present disclosure relates to painting assemblies, and more particularly to painting assemblies including a dolly for supporting a paint sprayer or paint container.

### BACKGROUND OF THE DISCLOSURE

A dolly can be used to support and transport a paint sprayer and a paint container.

### SUMMARY OF THE DISCLOSURE

The present disclosure provides, in one aspect, a painting assembly configured to removably support a paint container having an outer surface. The painting assembly may include a paint sprayer for dispensing paint. The paint sprayer may include a mounting portion with a support portion and a flange, a motor, a pump configured to driven by the motor, a siphon line configured to draw paint from the paint container, and a dispensing line configured to dispense paint via pressure from the pump. The painting assembly may also include a dolly having a base and a plurality of wheels. The base may have a sidewall with an upper edge. When the paint container is received in the base, the support portion of the mounting portion may be configured to rest on the paint container and the flange may be configured to extend over the outer surface of the paint container, such that the paint sprayer may be supported on the paint container and inhibited from moving in a lateral direction off of the paint container. When the paint container is not received in the base, the support portion of the mounting portion may be configured to rest on the upper edge of the sidewall and the flange may be configured to extend over the sidewall of the base, such that the paint sprayer may be supported on the dolly and inhibited from moving in a lateral direction off of the base.

The present disclosure provides, in another aspect, a dolly configured to removably support a paint container. The dolly may include a base having a sidewall with an upper edge, and a plurality of wheels. The dolly may also include a lever pivotable between a locked position and an unlocked position. The lever may include a cam member. When the paint container is received in the base and the lever is in the locked position, the cam member may be configured to engage against the paint container. When the paint container is received in the base and the lever is in the unlocked position, the cam member may be configured to be spaced from the paint container.

The present disclosure provides, in yet another aspect, a painting assembly configured to removably support a paint container having an outer surface. The painting assembly may include a paint sprayer for dispensing paint. The paint sprayer may include a mounting portion with a support portion, a flange, and a mounting portion lever that is moveable between a locked position and an unlocked position. The paint sprayer may also include a motor, a pump configured to driven by the motor, a siphon line configured to draw paint from the paint container, and a dispensing line configured to dispense paint via pressure from the pump. The painting assembly further may include a dolly including a base having a sidewall with an upper edge, a plurality of wheels, and a dolly lever moveable between a locked position and an unlocked position. When the paint container is received in the base, the support portion may be configured to rest on the paint container and the flange may be configured to extend over the outer surface of the paint container, such that the paint sprayer may be supported on the paint container and inhibited from moving in a lateral direction off of the paint container. When the paint container is not received in the base, the support portion may be configured to rest on the upper edge of the sidewall and the flange may be configured to extend over the sidewall of the base, such that the paint sprayer may be supported on the dolly and inhibited from moving in a lateral direction off of the base. When the paint container is received in the base and the dolly lever is in locked position, the paint container may be inhibited from being removed from the base in a vertical direction. When the paint container is received in the base and the dolly lever is in the unlocked position, the paint container can be removed from the base in a vertical direction. When the support portion is on the paint container, the flange is extended over the outer surface of the paint container, and the mounting portion lever is in the locked position, the paint sprayer may be inhibited from being removed from the paint container in the vertical direction. When the support portion is on the paint container, the flange is extended over the outer surface of the paint container, and the mounting portion lever is in the unlocked position, the paint sprayer can be being removed from the paint container in the vertical direction.

Other features and aspects of the disclosure will become apparent by consideration of the following detailed description and accompanying drawings.

### BRIEF DESCRIPTION OF THE DRAWINGS

FIG. 1 is a perspective view of a painting assembly including a dolly supporting a paint container that is supporting a paint sprayer.

FIG. 2 is another perspective view of the dolly of FIG. 1 supporting the paint container of FIG. 1, which is supporting the paint sprayer of FIG. 1.

FIG. 3 is a perspective view of the dolly of FIG. 1 supporting the paint sprayer of FIG. 1.

FIG. 4 is another perspective view of the dolly of FIG. 1 supporting the paint sprayer of FIG. 1.

FIG. 5 is another perspective view of the dolly of FIG. 1 supporting the paint sprayer of FIG. 1.

FIG. 6 is another perspective view of the dolly of FIG. 1 supporting the paint sprayer of FIG. 1.

FIG. 7 is a plan view of the dolly of FIG. 1 supporting the bucket of FIG. 1.

FIG. 8 is a perspective view of another embodiment of a painting assembly including a dolly supporting a paint container that is supporting another embodiment of a paint sprayer.

FIG. 9 is a perspective view of the dolly of FIG. 8.

FIG. 10 is an enlarged, cross-sectional view of the dolly of FIG. 8 supporting the paint container of FIG. 8 with a dolly lever in a locked position.

FIG. 11 is a perspective view of the dolly of FIG. 8 supporting the paint sprayer of FIG. 8.

FIG. 12 is a plan view of the paint container of FIG. 8 supporting the paint sprayer of FIG. 8, with a dispensing line stored in a first position.

FIG. 13 is a plan view of the paint container of FIG. 8 supporting the paint sprayer of FIG. 8, with the dispensing line stored in a second position.

FIG. 14 is an enlarged, cross-sectional view of the paint container of FIG. 8 supporting the paint sprayer of FIG. 8, with a mounting portion lever in a locked position.

FIG. 15 is a plan view of the dolly of FIG. 8 supporting a different paint container, with the paint sprayer of FIG. 8 rested on a support surface.

FIG. 16 is a plan view of the dolly of FIG. 8 supporting the paint container of FIG. 15, with the paint sprayer of FIG. 8 being supported on a side of the dolly of FIG. 8.

FIG. 17 is a plan view of the dolly of FIG. 8.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

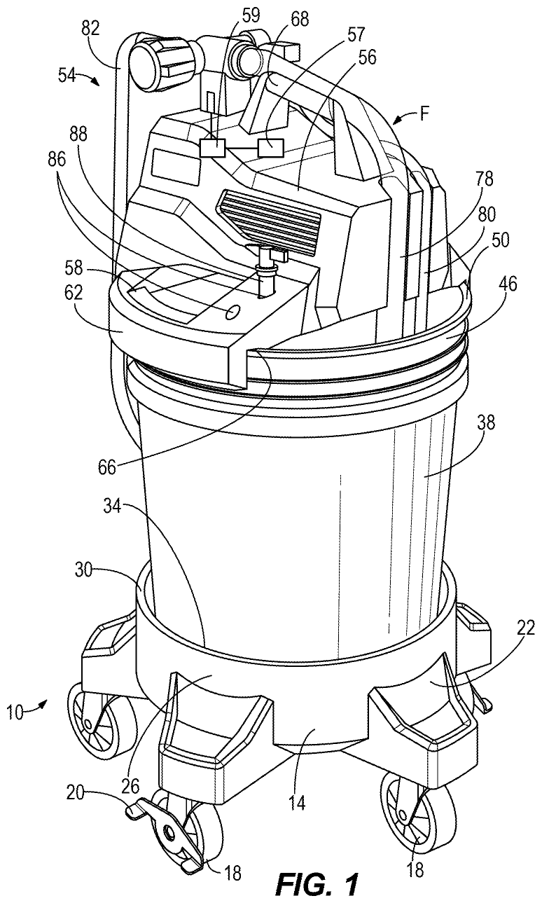

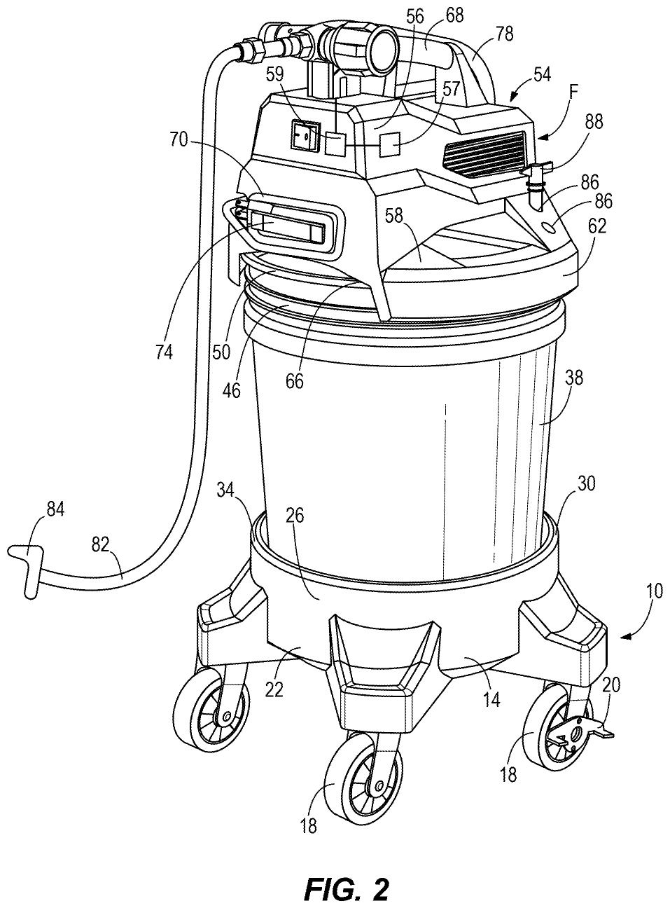

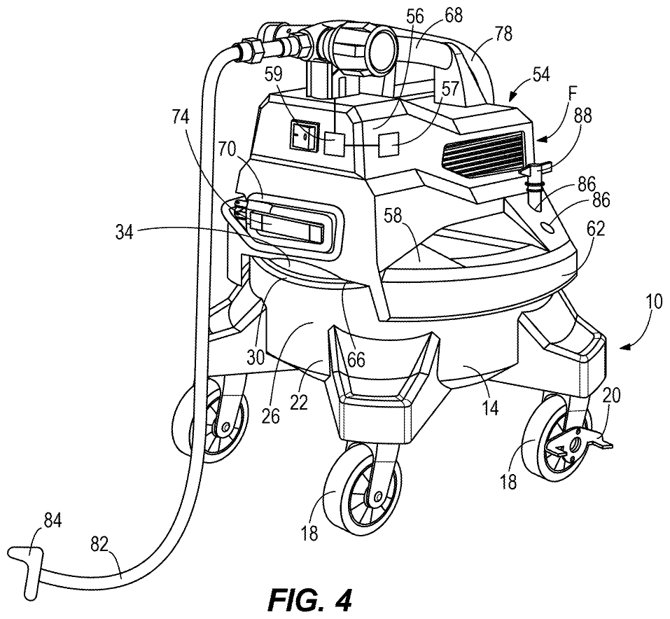

As shown in FIGS. 1-7, a dolly 10 may include a base 14 and a plurality of wheels 18 extending from the base 14. In the illustrated embodiment, the wheels 18 may be caster wheels. One or more of the wheels 18 may be lockable in a fixed position via a lock actuator 20. In some embodiments, the wheels 18 may have a diameter of 2 inches, but in other embodiments, the wheels 18 can have greater or smaller diameters. In the illustrated embodiment, the dolly 10 may have five wheels 18, but in other embodiments can include more or fewer wheels 18. The base 14 may include a sidewall 22 having an outer surface 26 and an upper edge 30. An aperture or well 34 may be defined within the sidewall 22. In the illustrated embodiment, the sidewall 22 may be cylindrical, such that a paint container, such as a five gallon paint bucket 38, can be placed within the well 34, as shown in FIGS. 1 and 2. The bucket 38 may have an outer surface 46 and an upper edge 50.

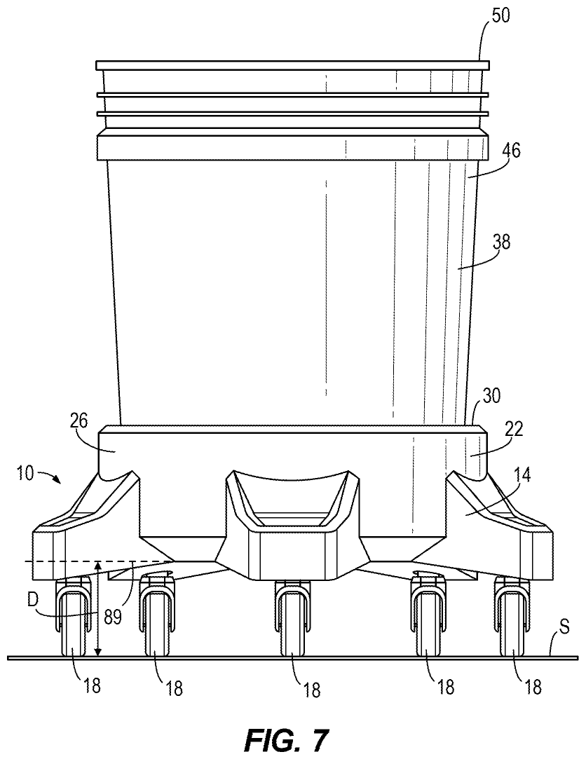

Within the well 34, the base 14 may include one or more holes for draining paint or other liquid that has accumulated in the well 34. Within the well 34, the surface on which the bucket 38 rests may have a pitch, such that the surface is not parallel to a support surface S (FIG. 7) on which the wheels 18 of the base 14 rests. Thus, the bucket 38 may be slightly tilted when placed in the well 34, causing paint or other liquid to tend to flow towards one side of the bucket 38. In some embodiments, the base 14 may be formed of a glass filled plastic.

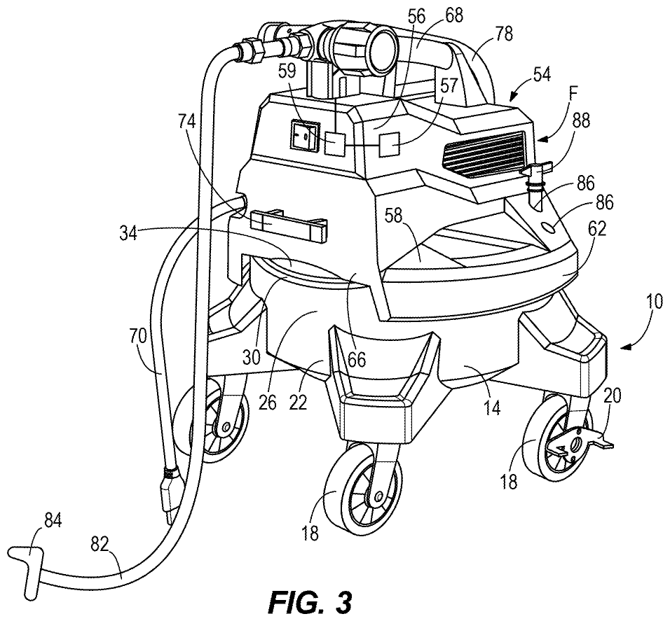

As shown in FIGS. 3-6, the dolly 10 may also be adapted to support a paint sprayer 54. In some embodiments, the paint sprayer 54 may be an airless paint sprayer. The paint sprayer 54 may include a housing 56 that houses a motor 57 to drive a pump 59 (shown schematically). In some embodiments, the housing 56 may be formed from glass filled plastic. The paint sprayer 54 may include two mounting portions 58, each having a flange 62 and a support portion 66. Thus, as shown in FIGS. 1 and 2, the dolly 10 can be used to receive the bucket 38 within the well 34, and the paint sprayer 54 can be supported on the bucket 38. Specifically, the flanges 62 may extend along the outer surface 46 of the bucket 38, while the support portions 66 may rest on top of the upper edge 50 of the bucket 38. The support portions 66 may provide support for the sprayer assembly 54, while the flanges 62 may inhibit the sprayer assembly 54 from moving in a lateral direction off of the bucket 38. In other words, if a lateral force F is exerted on the sprayer assembly 54 while the sprayer assembly 54 is supported by the bucket 38, the flanges 62 may inhibit the sprayer assembly 54 from being slid over and off of the bucket 38. In this way, the efficiency associated with a painting project may be improved, and paint waste may be prevented.

Additionally, or alternatively, as shown in FIGS. 3-6, the paint sprayer 54 may be supported directly on the dolly 10 for, e.g., during storage and/or the like. Specifically, the flanges 62 may extend along the outer surface 26 of the sidewall 22, while the support portions 66 may rest on top of the upper edge 30 of the sidewall 22. The support portions 66 may provide support for the sprayer assembly 54, while the flanges 62 may inhibit the sprayer assembly 54 from moving in a lateral direction off of the dolly 10. In other words, if a lateral force F is exerted on the sprayer assembly 54 while the sprayer assembly 54 is supported by the dolly 10, the flanges 62 may inhibit the sprayer assembly 54 from being slid over and off of the dolly 10.

In the illustrated embodiment, the paint sprayer 54 may include a handle 68 and a power cord 70 adapted to be plugged into an AC power source so the paint sprayer 54 can receive AC power. The paint sprayer 54 may also include a storage bracket 74 for wrapping and/or storing the power cord 70 when it is not in use. The paint sprayer 54 may also include a siphon tube 78 for drawing paint from the bucket 38 into the pump 59 during operation and a return tube 80 for returning excess paint from the pump 59 during operation back into the bucket 38 to reduce waste. Because the surface in the well 34 on which the bucket 38 rests may have a pitch, causing the bucket 38 to slightly tilt when placed in the well 34, it may be easier, more effective, and/or more efficient for the siphon tube 78 to draw up paint or other liquid from the bucket 38, because the paint or other liquid will tend to flow toward the side of the bucket 38 where the siphon tube 78 is arranged.

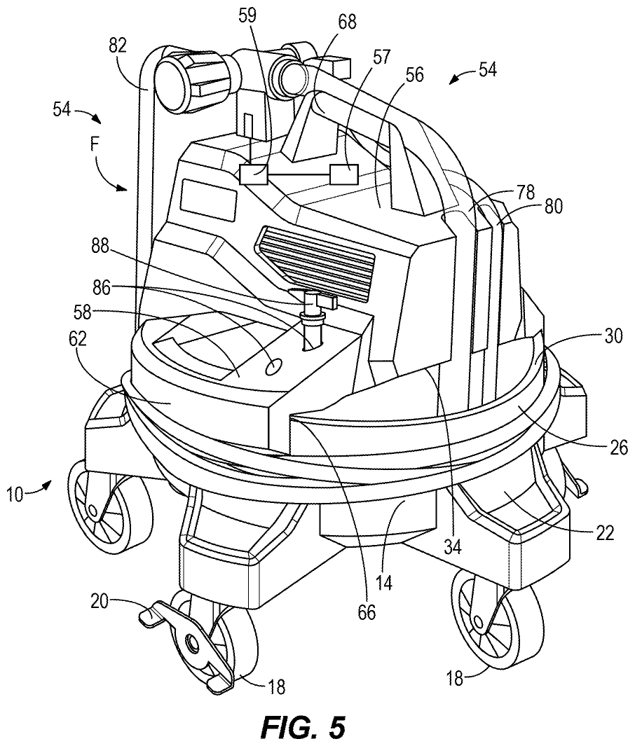

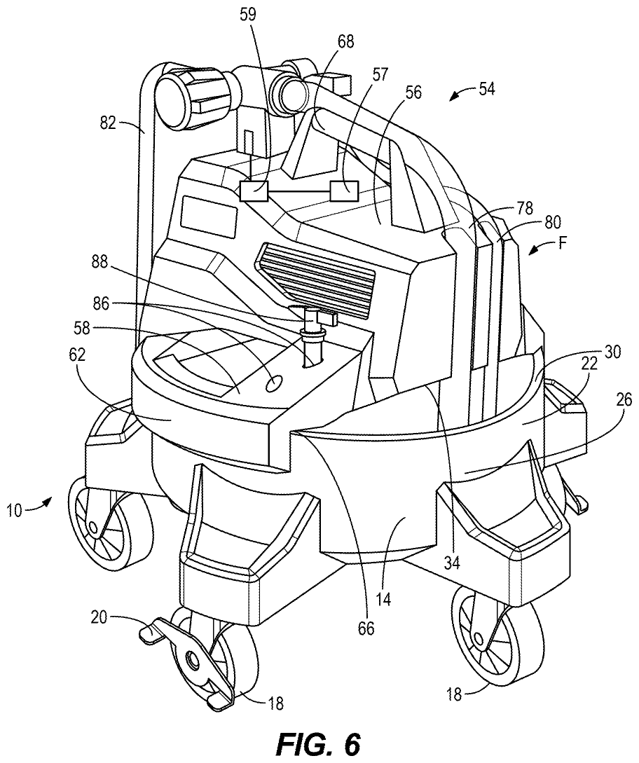

The paint sprayer 54 also may include a dispensing hose 82 for dispensing paint through a nozzle 84 (shown schematically) or other dispensing apparatus via pressure produced by the pump 59. When the paint sprayer 54 is not in use, the paint sprayer 54 may be stored on the dolly 10 as described above, and the dispensing hose 82 can be wrapped around the sidewall 22 of base 14 as shown in FIG. 5, or stored within the well 34. The siphon and return tubes 78, 80 may also be stored within the well 34 when the paint sprayer 54 is not in use, as shown in FIGS. 5 and 6. As shown in FIGS. 1-6, the mounting portions 58 may each include one or more recesses 86 for storing one or more spray tips 88 to be used with the nozzle 84. As shown in FIG. 7, a bottom 89 of the base 14 may be elevated above the support surface S on which the wheels 18 rest by a distance D. In some embodiments, the distance D may be about 3 inches. In other embodiments, the distance D can be greater or smaller than about 3 inches. Because the wheels 18 are radially offset from the base 14, the distance D may be sufficiently small enough to provide the dolly 10, paint bucket 38, and paint sprayer 54 with a low enough center of gravity that makes the entire operational setup of FIG. 1 difficult to topple over. In operation, as shown in FIGS. 1 and 2, the dolly 10 supports the bucket 38, which in turn supports the paint sprayer 54. Thus, an operator can move the bucket 38 and paint sprayer 54 simply by moving dolly 10 along wheels 18 from location to location at a job site.

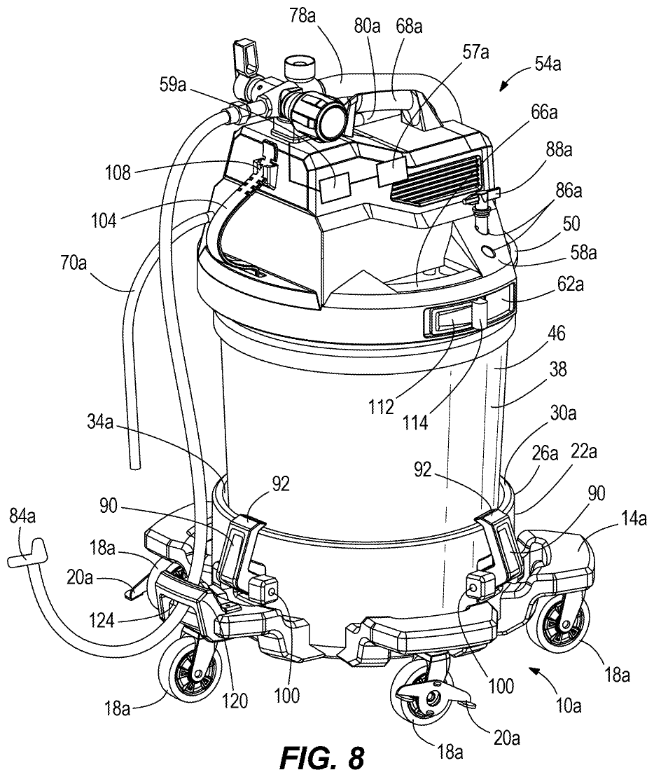

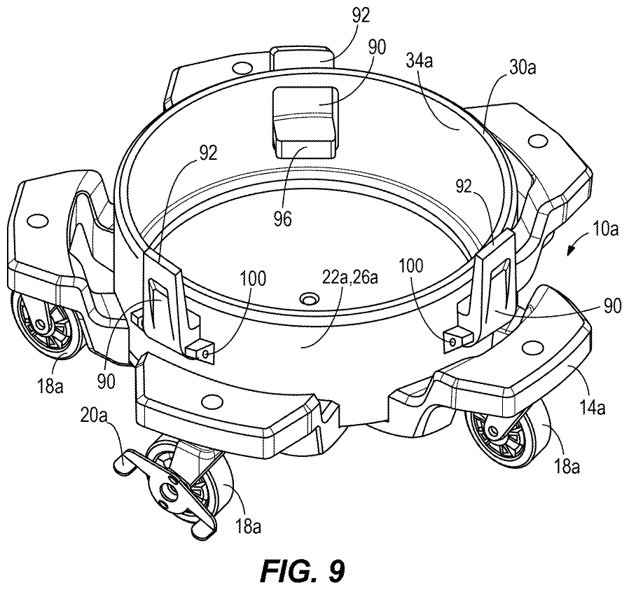

Another embodiment of a dolly 10a and paint sprayer 54a is shown in FIGS. 8-17. The dolly 10a and paint sprayer 54a are substantially similar to the dolly 10 and paint sprayer 54 of FIGS. 1-7, with like parts having an “a” annotation and the following differences and additions explained below.

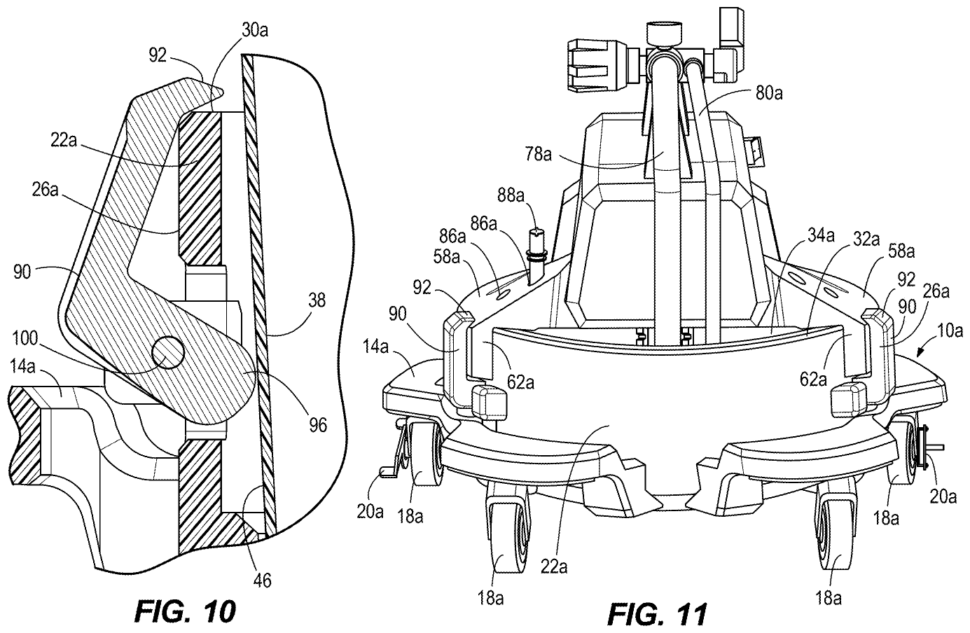

The dolly 10a may include one or more levers 90 on the sidewall 26a. Each lever 90 may include an upper hook 92 and an inner cam member 96. Each lever 90 may be movable between a locked position (FIGS. 8-11), in which the upper hook 92 is pivoted toward the upper edge 30a of the sidewall 22a and the inner cam member 96 is pivoted far enough toward the bucket 38a to a position in which the inner cam member 96 engages the outer surface 46 of bucket 38a, and an unlocked position, in which the upper hook 92 is pivoted away from the upper edge 30a of the sidewall 22a and the inner cam member 96 pivots far enough away from the bucket 38a to a position in which the inner cam member 96 is spaced from the outer surface 46 of bucket 38a. Specifically, the levers 90 may each pivot about and/or respective to a pivot joint 100 on the sidewall 26a between the locked and unlocked positions. Thus, as shown in FIGS. 8 and 10, when the bucket 38 is in the well 34a of the base 14a and the levers 90 are moved to the locked positions, the bucket 38 may be inhibited from being removed from the well 34a in a vertical direction, due to the inner cam members 96 of the levers 90 clamping the bucket 38 in the well 34a. However, when the levers 90 are moved to the unlocked positions, the bucket 38 can be removed because the inner cam members 96 no longer engage the outer surface 46 of bucket 38. In this way, retention of the bucket 38 during a painting project may be improved.

Also, as shown in FIG. 11, when the bucket 38 is removed, the paint sprayer 54a may be stored upon the upper edge 30a of the sidewall 22a, and the levers 90 may be moved to the locked positions, the upper hooks 92 may be moved over the mounting portions 58a of the paint sprayer 54a, thus inhibiting the paint sprayer 54a from being removed from the base 14a in a vertical direction. However, when the levers 90 are moved to their unlocked position, the paint sprayer 54a can be removed because the upper hooks 92 no longer vertically restrain the mounting portions 58a.

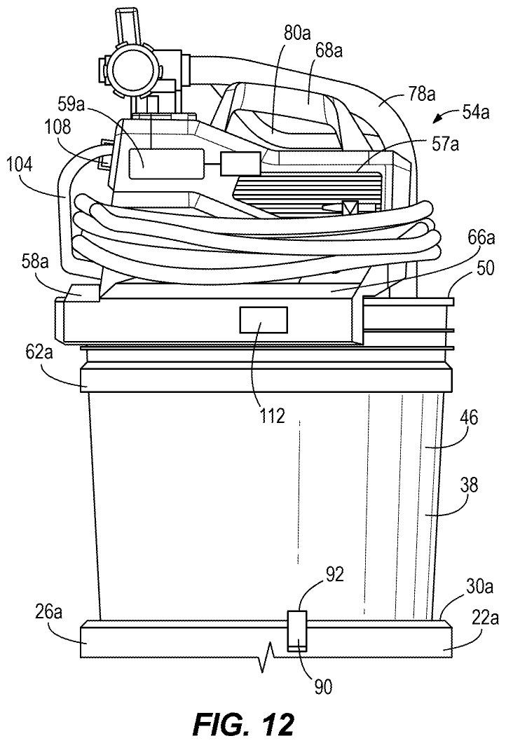

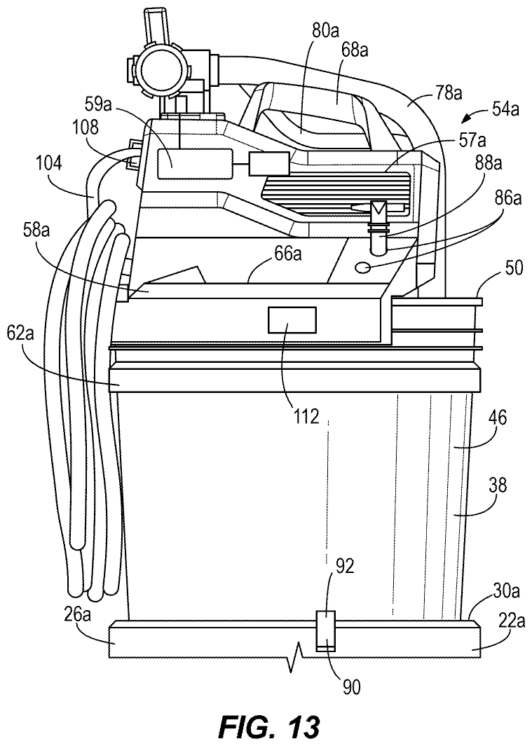

As shown in FIGS. 8, 12 and 13, the paint sprayer 54a may include a flexible strap 104 that can be selectively secured to the housing 56a at a fixing point 108. Thus, as shown in FIG. 12, when the dispensing hose 82a is not in use, the operator can wrap the dispensing hose 82a around the housing 56a and then secure the dispensing hose 82a to the housing 56a by affixing the flexible strap 104 to the fixing point 108. Or, as shown in FIG. 13, when the dispensing hose 82a is not in use, the operator can drape or hang the dispensing hose 82a from the flexible strap 104 while the flexible strap 104 is secured to the fixing point 108. In this way, damage caused to the dispensing hose 82a (e.g., due to being improperly secured) may be minimized or reduced.

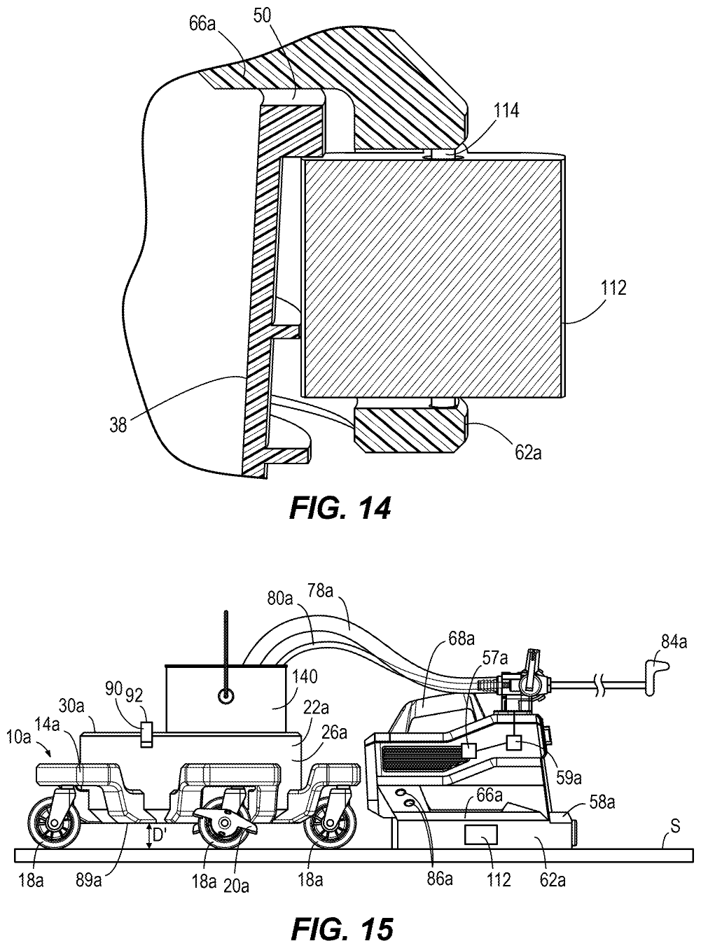

With reference to FIGS. 8 and 12-16, the paint sprayer 54a may include a lever 112 on each flange 62a of each mounting portion 58a. Each lever 112 may be moveable between a locked position (FIGS. 8 and 12-16) and an unlocked position via a pivot joint 114 (FIG. 14) in the flange 62a. As shown in FIG. 14, in the locked position, an inner cam member 116 of the lever 112 may be engaged against the outer surface 46 of the bucket 38, such that the paint sprayer 54a may be inhibited from being removed from the bucket 38 in a vertical direction. In the unlocked position of the levers 112, the inner cam members 116 may be pivoted off of the outer surface 46 of the bucket 38 to a position in which the inner cam members 116 are spaced from the outer surface 46 of the bucket 38, such that the paint sprayer 54a may be removed from the bucket 38 in a vertical direction.

As shown in FIG. 8, the base 14a may include an upwardly extending flange 120 with an aperture 124 defined therethrough. Thus, during a paint spraying operation, the dispensing hose 82a can be set through the aperture 124. By securing the dispensing hose 82a close to the base 14a, there is less of a chance of the operator tugging on the dispensing hose 82a in a manner that would topple the dolly 10a, bucket 38, and paint sprayer 58a. In this way, paint spillage and waste may be minimized.

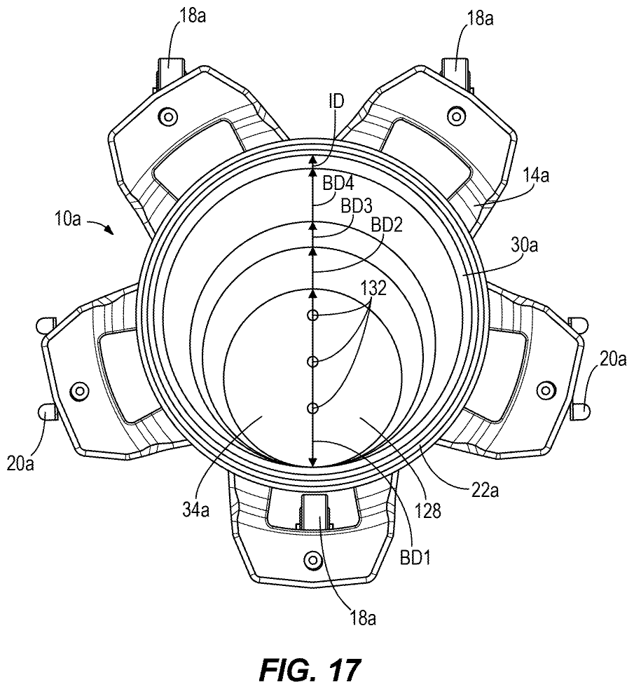

As shown in FIG. 17, like the base 14 and well 34 of the dolly 10, within the well 34a, a surface 128 on which the bucket 38 rests may include one or more holes 132 for draining paint or other liquid that has accumulated in the well 34a. Also, the surface 128 may have a pitch, such that the surface 128 is not parallel to the support surface S on which the wheels 18a of the base 14a rest. Thus, the bucket 38 may be slightly tilted when placed in the well 34a, causing paint or other liquid to tend to flow towards one side of the bucket 38, making it easier for the siphon tube 78a to draw paint from the bucket 38 into the pump assembly 59a. In this way, a larger volume of paint may be utilized during a painting project, thereby reducing waste.

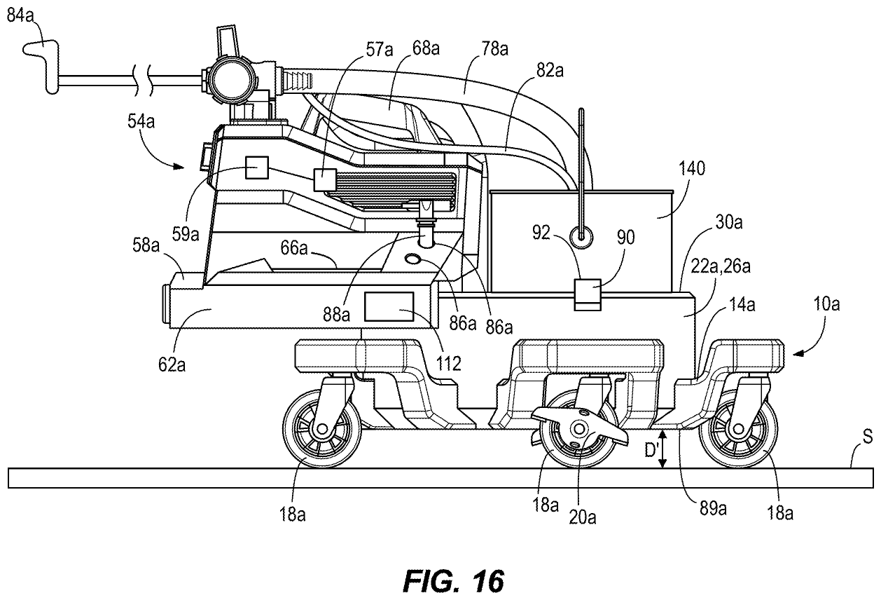

In some embodiments, the wheels 18a may have a diameter of about 3 inches, such as about 2.75 inches, but in other embodiments the diameters can be greater or smaller than about 3 inches. In some embodiments, as shown in FIGS. 15 and 16, the bottom 89a of the base 14 may be elevated above the support surface S by a distance D′. In some embodiments, the distance D may be less than or equal to about 2 inches, such as about 1.5 inches. For example, the distance D may be about 1.5 inches, about 1.0 inches, or any distance D in a subrange of distances therebetween. In other embodiments, the distance D′ can be greater than 2 inches or smaller than 1 inch. Because the wheels 18a are radially offset from the base 14a, the distance D′ may be sufficiently small enough to provide the dolly 10a, paint bucket 38, and paint sprayer 54a with a low enough center of gravity that it makes the entire operational setup shown in FIG. 8 difficult to topple over. As shown in FIG. 17, the sidewall 22a of the base 14a may have an inner diameter ID that is sufficiently great enough to accommodate at least four different bucket diameters BD1, BD2, BD3, BD4, and in some instances, more than four different bucket diameters. For example, the illustrated base 14a may accommodate buckets having ½ gallon, 1 gallon, 2 gallon and 5 gallon capacities.

FIG. 8 illustrates a first operational setup, in which the dolly 10a may support the bucket 38, which in turn supports the paint sprayer 54a, because the outer surface 46 has a wide enough outer diameter to support the mounting portions 58 of the paint sprayer 54a. Thus, an operator can move the bucket 38 and paint sprayer 54a simply by moving dolly 10a via wheels 18a from location to location at a job site.

However, when using a smaller size bucket than bucket 38, such as a 1 gallon bucket 140 shown in FIGS. 15 and 16, the bucket 140 may not capable of supporting the paint sprayer 54a. Thus, when using bucket 140, FIG. 15 illustrates a second operational setup, in which the dolly 10a supports the bucket 140, and the paint sprayer 54a is set on the support surface S and operated therefrom. Alternatively, FIG. 16 illustrates a third operational setup, in which the dolly 10a supports the bucket 140, and the paint sprayer 54a is set on a side of the upper ledge 30a of the sidewall 26a. Finally, FIG. 11 shows a storage setup, in which the bucket 38 has been removed and the paint sprayer 54a has been mounted on and locked to the base 14a, as described above.

Various features of the disclosure are set forth in the following claims.

What is claimed is:

1. A painting assembly configured to removably support a paint container having an outer surface, the painting assembly comprising:
a paint sprayer for dispensing paint, the paint sprayer including:
a mounting portion with a support portion and a flange;
a motor;
a pump configured to driven by the motor;
a siphon line configured to draw paint from the paint container; and
a dispensing line configured to dispense paint via pressure from the pump; and
a dolly having a base and a plurality of wheels, the base having a sidewall with an upper edge,
wherein, when the paint container is received on the base, the support portion of the mounting portion is configured to rest on the paint container and the flange is configured to extend over the outer surface of the paint container, such that the paint sprayer is supported on the paint container and inhibited from moving in a lateral direction off of the paint container, and
wherein, when the paint container is not received on the base, the support portion of the mounting portion is configured to rest on the upper edge of the sidewall and the flange is configured to extend over the sidewall of the base, such that the paint sprayer is supported on the dolly and inhibited from moving in a lateral direction off of the base.

2. The painting assembly of claim 1, wherein:
the dolly includes a lever configured to move between a locked position and an unlocked position, and
when the paint container is received in the base and the lever is in the locked position, the paint container is not removable from the base in a vertical direction, and
when the paint container is received in the base and the lever is in the unlocked position, the paint container is removable from the base in a vertical direction.

3. The painting assembly of claim 2, wherein the lever pivots between the locked position and the unlocked position.

4. The paint assembly of claim 2, wherein:
the lever includes a cam member, and
when the paint container is received in the base and the lever is in the locked position, the cam member is engaged against the outer surface of the paint container, and
when the paint container is received in the base and the lever is in the unlocked position, the cam member is spaced from the outer surface of the paint container.

5. The painting assembly of claim 2, wherein:
when the paint container is not received in the base, the support portion is on the upper edge of the sidewall of the base and the lever is in the locked position such that the paint sprayer is not removable from the base in the vertical direction, and
when the paint container is not received in the base, the support portion is on the upper edge of the sidewall of the base and the lever is in the unlocked position such that the paint sprayer is removable from the base in the vertical direction.

6. The painting assembly of claim 5, wherein:
the lever includes a hook, and
when the paint container is not received in the base, the support portion is on the upper edge of the sidewall of the base and the lever is in the locked position such that the hook is moved over the mounting portion, and
when the paint container is not received in the base, the support portion is on the upper edge of the sidewall of the base and the lever is in the unlocked position such that the hook is moved away from the mounting portion.

7. The painting assembly of claim 1, wherein the paint sprayer includes at least one recess configured to receive a spray tip for the paint sprayer.

8. The painting assembly of claim 1, wherein the paint sprayer includes a handle.

9. The painting assembly of claim 1, wherein the base of the dolly has a surface on which the paint container is configure to rest, and
wherein the surface has a pitch.

10. The painting assembly of claim 9, wherein the surface has one or more holes for draining a liquid accumulated in the base.

11. The painting assembly of claim 1, wherein the paint sprayer includes a strap that is removably coupled to the paint sprayer.

12. The painting assembly of claim 1, wherein:
the mounting portion includes a lever moveable between a locked position and an unlocked position, and
when the support portion is on the paint container, the flange is extended over the outer surface of the paint container and the lever is in the locked position such that the paint sprayer is not removable from the paint container in a vertical direction, and
when the support portion is on the paint container, the flange is extended over the outer surface of the paint container and the lever is in the unlocked position such that the paint sprayer is removable from the paint container in the vertical direction.

13. The painting assembly of claim 12, wherein the lever pivots between the locked position and the unlocked position.

14. The painting assembly of claim 12, wherein:
the lever includes a cam member, and
when the support portion is on the paint container, the flange is extended over the outer surface of the paint container and the lever is in the locked position such that the cam member is engaged against the outer surface of the paint container, and
when the support portion is on the paint container, the flange is extended over the outer surface of the paint container and the lever is in the unlocked position such that the cam member is spaced from the outer surface of the paint container.

15. The painting assembly of claim 1, wherein the base of the dolly includes a flange having an aperture configured to receive the dispensing line of the paint sprayer.

16. The painting assembly of claim 1, wherein at least one of the plurality of wheels is lockable.

17. A dolly configured to removably support a paint container, the dolly comprising:
a base having a sidewall with an upper edge;
a plurality of wheels; and
a lever pivotable between a locked position and an unlocked position, the lever including a cam member,
wherein, when the paint container is received in the base and the lever is in the locked position, the cam member is configured to engage against the paint container, and
wherein, when the paint container is received in the base and the lever is in the unlocked position, the cam member is configured to be spaced from the paint container.

18. The dolly of claim 17, wherein:
the lever includes a hook, and
when the lever is in the locked position, the hook is moved over the upper edge of the sidewall, and
when the lever is in the unlocked position, the hook is moved away from the upper edge of the sidewall.

19. The dolly of claim 17, wherein a distance between a bottom of the base and a support surface on which the plurality of wheels rest is less than or equal to 1.5 inches.

20. A painting assembly configured to removably support a paint container having an outer surface, the painting assembly comprising:
a paint sprayer for dispensing paint, the paint sprayer including:
a mounting portion with a support portion;
a flange;
a mounting portion lever that is moveable between a locked position and an unlocked position;
a motor;
a pump configured to driven by the motor;
a siphon line configured to draw paint from the paint container; and
a dispensing line configured to dispense paint via pressure generated by the pump; and
a dolly including:
a base having a sidewall with an upper edge;
a plurality of wheels; and
a dolly lever moveable between a locked position and an unlocked position,
wherein, when the paint container is received in the base, the support portion is configured to rest on the paint container and the flange is configured to extend over the outer surface of the paint container such that the paint sprayer is supported on the paint container and inhibited from moving in a lateral direction off of the paint container,
wherein, when the paint container is not received in the base, the support portion is configured to rest on the upper edge of the sidewall and the flange is configured to extend over the sidewall of the base such that the paint sprayer is supported on the dolly and inhibited from moving in a lateral direction off of the base,
wherein, when the paint container is received on the base and the dolly lever is in the locked position, the paint container is not removable from the base in a vertical direction,
wherein, when the paint container is received on the base and the dolly lever is in the unlocked position, the paint container is removable from the base in the vertical direction,
wherein, when the support portion is on the paint container, the flange is extended over the outer surface of the paint container and the mounting portion lever is in the locked position such that the paint sprayer is inhibited from being removed from the paint container in the vertical direction, and
wherein, when the support portion is on the paint container, the flange is extended over the outer surface of the paint container and the mounting portion lever is in the unlocked position such that the paint sprayer is removable from the paint container in the vertical direction.
